(19) United States
(12) Patent Application Publication
(10) Pub. No.: US 2012/0042474 A1
(43) Pub. Date: Feb. 23, 2012

(54) DOOR MECHANISM

(75) Inventor: Yoash Kachtan, Kibbutz Dafna (IL)

(73) Assignee: PLASAN SASA LTD., M.P. Marom Hagalil (IL)

(21) Appl. No.: 13/191,259

(22) Filed: Jul. 26, 2011

(30) Foreign Application Priority Data
Jul. 26, 2010 (IL) 207238

(51) Int. Cl. E05D 11/10; E05C 3/14

(52) U.S. Cl. 16/350; 292/203

(57) ABSTRACT

A retention mechanism for a hinge mechanism of a door. The retention mechanism comprises: (a) a first portion comprising a keeper and a biasing arrangement configured to bias the keeper toward a locking position, while allowing displacement of the keeper from the locking position to a disengaged position; and a second portion comprising a latch, the latch being configured to displace the keeper from its locking position to its disengaged position and comprising a seat for retaining the keeper therein in its locking position, so as to maintain a door in its open position when the keeper being retained in the seat. The retention mechanism, when operating in conjunction with a hinge mechanism of a door, comprises a clearance area in which, during pivoting of the door between its closed and open positions, there is no contact between the keeper and the latch.

### CROSS-REFERENCE TO RELATED APPLICATIONS

This application claims priority to Israel Patent Application No. 207238 filed on 26 Jul. 2010, the contents of which are incorporated herein, in their entirety, by this reference.

### TECHNICAL FIELD

Embodiments of the invention relate to mechanisms for retaining a door in an open position, and in particular for mechanisms for use with doors for armored vehicles.

### BACKGROUND

In vehicles, it is well known to provide a hinge mechanism associated with one or more doors thereof in order to facilitate opening/closing thereof, and/or to maintain the door in an open position by a retention mechanism. In armored vehicles, the door is typically heavier than in non-armored vehicles, and it is typically required that such mechanisms be designed to maintain a heavy door in an open position, even when the vehicle is on an incline or overturned.

There are known various retention mechanisms which operate in conjunction with hinge mechanisms. Examples of such mechanisms are discloses in U.S. Pat. No. 6,938,303, EP 1,306,505, and FR2655084.

### SUMMARY

According to one aspect of the presently disclosed subject matter, there is provided a retention mechanism for a hinge mechanism of a door. The hinge mechanism being configured for articulating a door to the sidewall of a vehicle so as to enable pivoting of the door relative to the sidewall about an axis between a closed position and an open position. The retention mechanism comprises:
a. a first portion comprising a keeper and a biasing arrangement configured to bias the keeper toward a locking position, while allowing displacement of the keeper from the locking position to a disengaged position;
b. a second portion comprising a latch, the latch being configured to displace the keeper from its locking position to its disengaged position and comprising a seat for retaining the keeper therein in its locking position, so as to maintain the door in its open position when the keeper being retained in the seat;

The retention mechanism, when operating in conjunction with the hinge mechanism, comprises a clearance area in which, during pivoting of the door between its closed and open positions, there is no contact between the keeper and the latch.

When the door is pivoted between its closed and open positions, the latch can be configured to pass through the clearance area between a first position in which the keeper and the latch are maximally distant from each other, and a second position in which the latch comes in contact with the keeper, the latch being configured for assuming a plurality of medial positions, in each of which, there is no contact between the latch and the keeper.

At the second position of the latch, the door can be configured to be in an intermediate position between the open position and the closed position of the door, and angled at a first angle with respect to the latter, and at its open position, the door can be rotated at a second angle with respect to its closed position, differing from the first angle.

The first position of the latch can be corresponding to the closed position of the door, and the second position of the latch can be corresponding to the intermediate position of the door.

The first angle can be between 20 to 50 degrees, and more specifically about 35 degrees.

The second angle can be between 50 to 80 degrees, and more specifically about 70 degrees.

The clearance area can be configured to provide pivoting of the door between its closed position to its intermediate position, while keeping the latch and the keeper at a contact-free configuration.

The retention mechanism can be configured for being attached to an exterior side of a vehicle.

The first and second portions can be isolated from one another in the closed position of the door.

The biasing arrangement can comprise:

a. a biasing plate configured to bear against the keeper; and

b. a spring configured to bias the biasing plate toward the keeper.

The first portion can comprise a housing configured to constrain the keeper to linear motion.

The retention mechanism can further comprise a first plate and a second plate articulated to one another by the hinge mechanism, each of the first and second portions being rigidly mounted to the plates, correspondingly.

The first and second plates can be configured to be attached to the door and the sidewall of the vehicle, correspondingly.

According to another aspect of the presently disclosed subject matter, there is provided a hinge mechanism configured for articulating a door to the sidewall of a vehicle so as to enable pivoting of the door relative to the sidewall about an axis, the mechanism comprising:
a. a first portion comprising a keeper and a biasing arrangement configured to bias the keeper toward a locking position, the first portion being configured to allow displacement of the keeper from the locking position; and
b. a second portion comprising a latch, the latch being configured to displace the keeper from its locking position and comprising an open seat for retaining the keeper therein in it locking position;
   the mechanism being configured for maintaining the door in an open position when the keeper is retained in the seat.

The hinge mechanism may be configured for being attached to an exterior side of the vehicle.

The seat may be, in both the open and closed positions of the door, open toward the exterior of the vehicle.

The first and second portions may be isolated from one another in the closed position of the door.

The keeper may be biased in a direction toward the axis.

The keeper may comprise a cylindrical portion.

The biasing arrangement may comprise:
a. a biasing plate configured to bear against the keeper;
b. at least one plunging rod connected to the biasing plate; and
c. a spring associated with each plunging rod configured to bias the biasing plate toward the keeper.

The first portion may comprise a housing configured to constrain the keeper to linear motion. The housing may comprise slots sized so as to allow the keeper to slide therewithin and configured for the constraining.

The latch may comprise a cam surface configured for the displacing of the keeper. The cam surface may be adjacent the seat.

The hinge mechanism may further comprise a first plate and a second plate articulated to one another by a hinge at the axis, each of the first and second portions being rigidly mounted to one of the plates. The hinge mechanism may be free of any element between the first portion and the hinge. The first portion may be mounted adjacent to the hinge. Each of the first and second plates may be configured to be attached to one of the door and sidewall of the vehicle.

The door may be an armored door.

The vehicle may be an armored vehicle.

According to another aspect of the presently disclosed subject matter, there is provided a vehicle comprising a hinge mechanism as per the above.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1 is a perspective view of a retention mechanism mounted on a hinge mechanism in a closed position of a door;

FIG. 2 is a perspective view of a retention mechanism mounted on the hinge mechanism illustrated in FIG. 1, in an open position of the door;

FIG. 3 is a perspective view of a biasing arrangement of the retention mechanism illustrated in FIGS. 1 and 2, with its housing removed for purposes of illustration;

FIG. 4 is an upper view of the retention mechanism mounted on the hinge mechanism of FIG. 1 in a closed position of a door, with its housing removed for purposes of illustration;

FIG. 5 is an upper view of the retention mechanism mounted on the hinge mechanism of FIG. 1 in an intermediate position of a door, with its housing removed for purposes of illustration; and

FIG. 6 is an upper view of the retention mechanism mounted on the hinge mechanism of FIG. 1 in an opened position of a door, with its housing removed for purposes of illustration.

FIGS. 7A-C illustrate another examples of the retention mechanism of FIG. 1 operating in conjunction with a hinge mechanism.

### DETAILED DESCRIPTION OF EMBODIMENTS

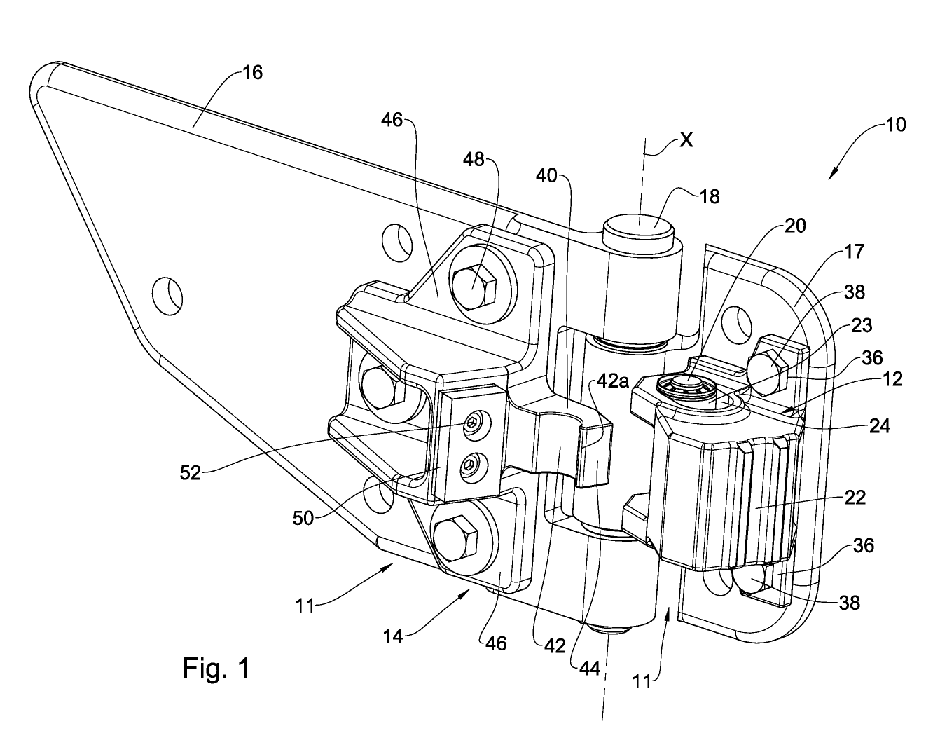

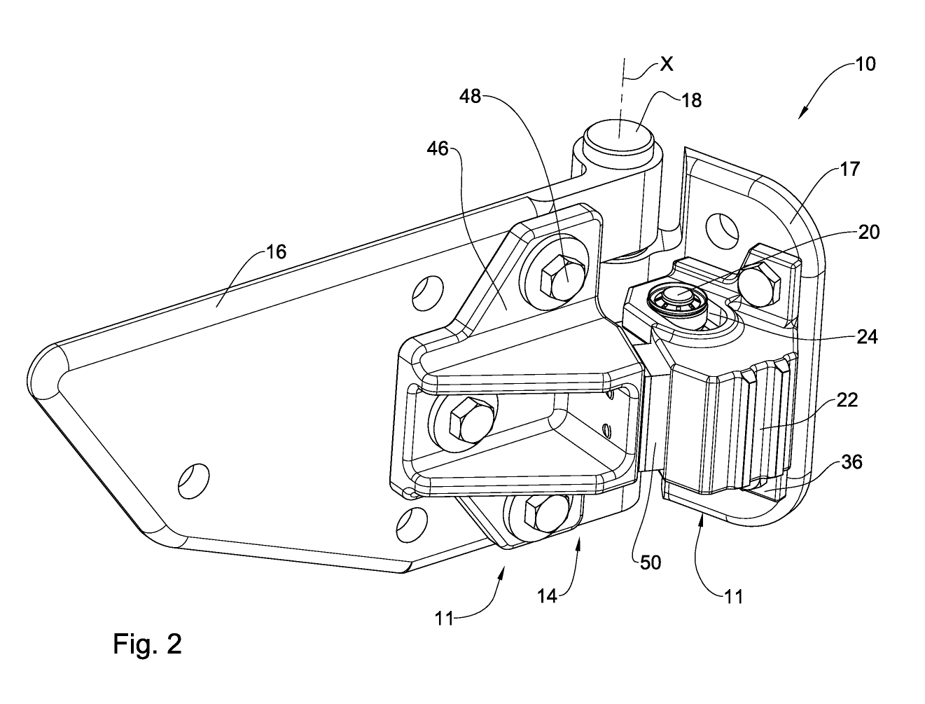

Reference is first made to FIGS. 1 and 2, illustrating a hinge mechanism 10 having a retention mechanism 11 mounted thereon. The hinge mechanism 10 is designed to hingedly articulate a door (not shown) to the sidewall of a vehicle (not illustrated), for example an armored door to an armored vehicle, so as to enable pivoting of the door relative to a sidewall of the vehicle about an axis X. The hinge mechanism 10 is designed and configured to be mounted and/or installed on the exterior side of the vehicle, i.e., on the exterior sides of the door and sidewall.

The retention mechanism 11 comprises a first portion 12 and a second portion 14, each of which is attached to plates 16 and 17 which are designed for attachment to one of the doors and its respective sidewall of the vehicle. The plates 16 and 17 are articulated to one another about a hinge 18, between an open position of the door (FIG. 2) and a closed position of the door (FIG. 1). The hinge 18 is coincident with and rotates about the axis X. Alternatively, the retention mechanism 11 may be designed such that the first and second portions 12, 14 may be attached directly to the door and sidewall without the necessity of providing the plates 16 and 17.

In the closed position of the door, the first and second portions 12, 14 may be isolated from one another, i.e., they only contact one another when the door is being brought into or out of its open position, and in the open position itself.

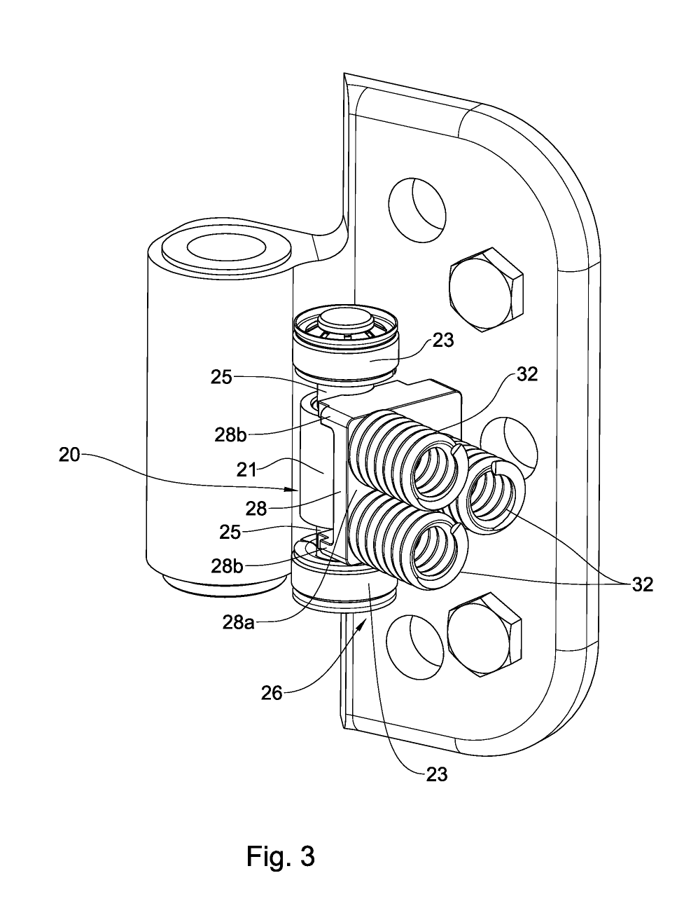

As best seen in FIG. 3, the first portion 12 comprises a keeper 20 being generally cylindrical and designed for retaining a corresponding element of the second portion 14, as will be explained below. As illustrated, the keeper 20 may comprise a cylindrical central portion 21 and rollers 23 at ends thereof, separated from the central portion by gaps 25.

A housing 22 (not illustrated in FIG. 3) of the first portion 12 is provided to contain the other element thereof. The housing 22 comprises slots 24 constraining the keeper 20 to sliding, e.g., linear, motion between a locking position (as illustrated in FIGS. 1, 2, and 3) and a disengaged position. The significance of these positions will be explained below. The slots 24 are formed so as to cooperate with the rollers 23 of the keeper 20 to ensure smooth motion thereof therein.

A plunger mechanism, which is generally indicated at 26, constituting a biasing arrangement, is provided to bias is provided in order to bias the keeper 20 toward the locking position in a direction toward the axis X, while allowing it to be displaced therefrom.

The plunger mechanism 26 comprises a biasing plate 28 configured to bear against the keeper 20, and three compression springs 32, disposed between the biasing plate 28 and the housing 22. The biasing plate 28 is formed with a biasing portion 28a for the bearing, and two extensions 28b sized so as to be received within the gaps 25 of the keeper 20, thus restricting axial motion thereof.

The housing 22 is further provided with flanges 36 facilitating rigid attachment of the first portion 12 to the plate 17 (or directly to the vehicle door or sidewall, if the retention mechanism 11 is designed to be attached directly to the vehicle), for example via bolts 38.

The second portion 14 comprises a latch 40 (not seen in FIG. 2) configured to cooperate with the keeper 20 for maintaining the door of the vehicle in an open position. As such, it comprises an open, concave seat 42 corresponding with the keeper 20 of the first portion 12, and a cam surface 44 designed to displace the keeper 20 from its locking position and being located adjacent the seat 42. The seat 42 is disposed such that it always faces toward the exterior of the vehicle.

The seat 42 is formed as an arc having a radius of curvature which is the same or slightly larger than that of the cylindrical central portion 21 of the keeper 20. As such, when the keeper 20 is retained therein (in the open position of the door), a large amount of force is required to pivot the door about the axis X.

The second portion 14 is further provided with flanges 46 facilitating rigid attachment thereof the plate 16 (or directly to the vehicle door or sidewall, if the retention mechanism 11 is designed to be attached directly to the vehicle), for example via bolts 48.

The second portion 14 may be further provided with a cushioning arrangement 50 disposed above the latch 40 (i.e., on the opposite side thereof from the axis X). The cushioning arrangement 50 is located so as to strike the housing 22 of the first portion 12 when the door is brought into its open position, thereby serving as an energy absorber, reducing noise and extending the useful life of the hinge mechanism 10.

The cushioning arrangement 50 may be made of any suitable material, such as rubber, foam, etc. In addition, it may be attached to the second portion 14 by screws 52, facilitating easy replacement thereof.

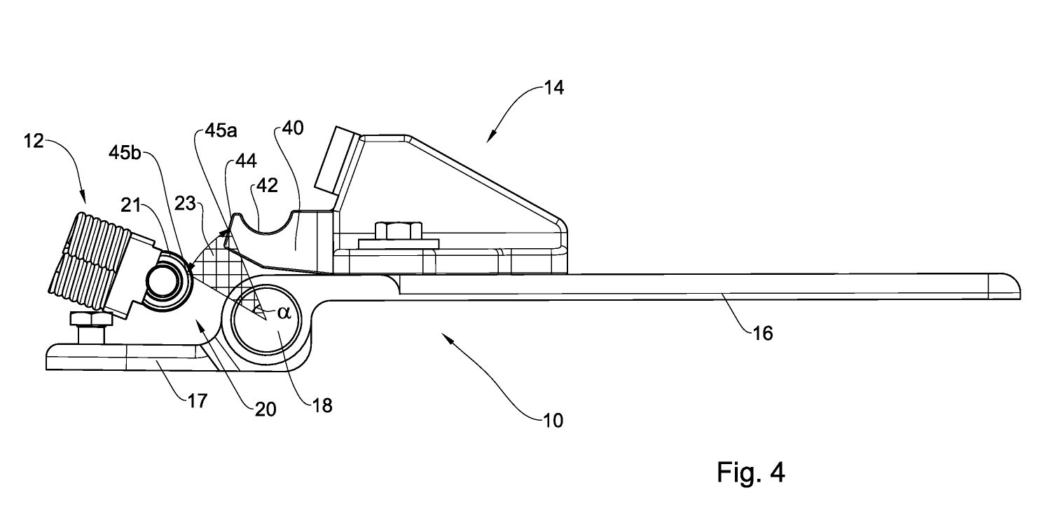

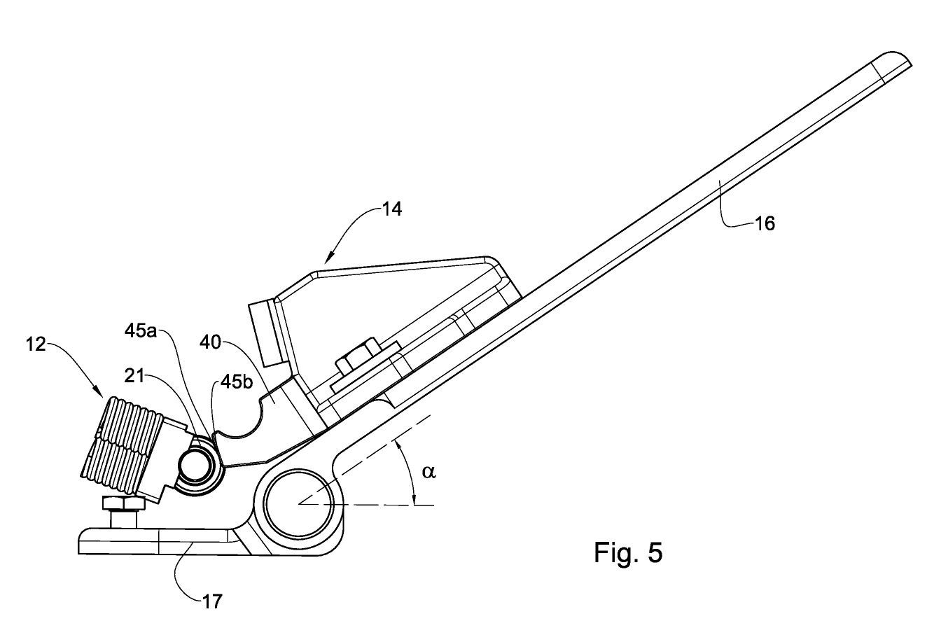

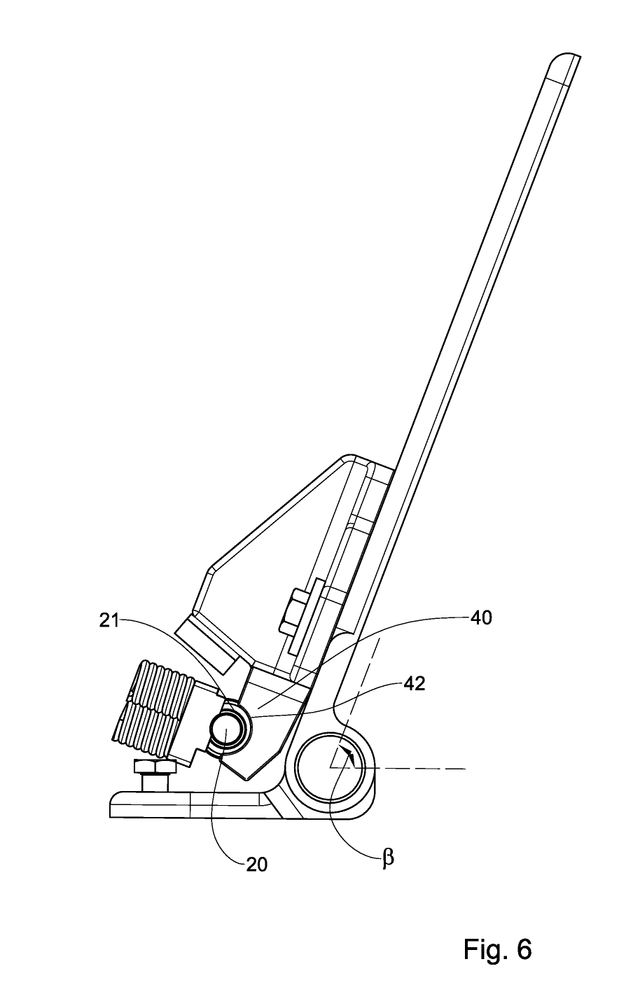

Reference is now made to FIGS. 4, 5 and 6, illustrating various stages of operation of the door and of the retention mechanism 11. The various stages of operating the door include the following positions: a closed position (FIG. 4) in which the keeper 20 and the latch 40 are not in contact with each other, an intermediate position (FIG. 5) in which the latch 40 is in contact (i.e., tangential) with the cylindrical portion 21 of the keeper 20, and an open position (FIG. 6) in which the cylindrical portion 21 is seated within the seat 42.

With particular reference to FIG. 4, which illustrates the closed position of a vehicle's door, the first and the second portions 12 and 14 are isolated from one another, and the latch 40 is disposed at its first position. In this closed position of the door and first position of the latch 40, the plates 16 and 17 are generally parallel/co-planar with one another, the latch 40 of the second portion 14 is separate, and maximally distant from the keeper 20 and its cylindrical central portion 21 of the first portion 12, and the keeper 20 is biased in its locking position. In the first position of the latch, a first point 45a of the cam surface 44 is maximally distant from a second point 45b of the cylindrical portion 21.

In addition, a clearance area 13 is observed in the form of a sector of a circle having a predetermined angle α, in which, during pivoting of the vehicle's door between its closed and open positions, no contact between the keeper 20 and the latch 40 takes place. The value of the angle α can be, for example, between 20 to 50 degrees, more particularly between 25 and 40 degrees and even more specifically about 35 degrees.

During the first stage of opening of the door, the door, and subsequently the latch 40 attached thereto revolve about the axis X toward the cylindrical central portion 21 of the second portion 12. At this stage, the latch 40 passes along the clearance area 13, and this provides a contact-free configuration of the door between its closed and intermediate positions. The term ‘contact-free’ means that there is no mechanical contact and friction between the keeper 20 and the latch 40. During the pivoting of the door between its closed and intermediate positions, the latch 40 assumes a plurality of medial positions, in each of which, there is no contact between the latch 40 and the keeper 20.

At the end of the first stage of opening the door, it takes its intermediate position, as illustrated in FIG. 5. In this position, the first and the second portions 12 and 14 are in contact with each other, and the latch 40 is disposed at its second position. In this second position of the latch 40, its cam surface 44 is tangential to the cylindrical portion 21 of the keeper 20, so that first and second point 45a and 45b are in contact with each other. In this figure, the door which is disposed at its intermediate position, between the open and the closed positions, is rotated (angled) at a first angle with respect to its closed position. The size of the first angle equals to the predetermined angle α of the clearance area 13. Therefore, its value can be also between 20 to 50 degrees, and more specifically 35 degrees.

When the latch 40 is disposed at the clearance area 13, between its first and the second positions, not including the second position, the first and second portions 12 and 14 are isolated from one another. Only when the latch 40 takes the second position, a contact between its cam surface 44 and the cylindrical portion 21 is created, and from this position, towards to closed position of the door, the pivoting of the door is not contact-free.

At a subsequent, second stage of opening the door, the latch 40 is already in contact with the cylindrical portion 21 of the keeper 20, and the cam surface 44 thereof urges the keeper 20 away from its locking position toward the disengaged position.

During this stage, the compression springs 32 are slightly compressed. Once the keeper 20 clears the cam surface 44, the compression springs 32 force the return of the keeper 20 toward its locking position, wherein it rests within the seat 42, thereby maintaining the door in an open position.

In FIG. 6, which illustrates the open position of a vehicle's door, the first and the second portions 12 and 14 are in contact with each other, and the cylindrical portion 21 of the keeper 20 is disposed at the seat 42 of the latch 40. In this figure, the door is rotated at a second angle β with respect to its closed position. The second angle is different from the first angle α. The value of the second angle β can be, for example, between 20 to 50 degrees, and more specifically 70 degrees. From the open position, a great deal of force is necessary to displace the cylindrical central portion 21 of the keeper 20 from the seat 42. This is at least partially due to the geometry of the leading edge 42a of the seat, which comprises an abrupt change of angle between the seat 42 and the cam surface 44 of the latch 40 immediately adjacent it. Once the necessary amount of force which acts to urge the door toward its closed position is supplied, the above takes place in reverse. Namely, the keeper 20 is displaced from its locking position toward its disengaged position, allowing the latch 40, and thus the door, to begin to move toward its intermediate and then to its closed position. As the door closes, the keeper 20 is forced out of the seat 42, by passing over the leading edge 42a thereof. Once the keeper 20 clears the leading edge 42a of the seat 42, the compression springs 32 force the return of the keeper toward its locking position, and the door takes its intermediate position. As the closing of the door continues, it freely passes in the clearance area 15 to its closed position.

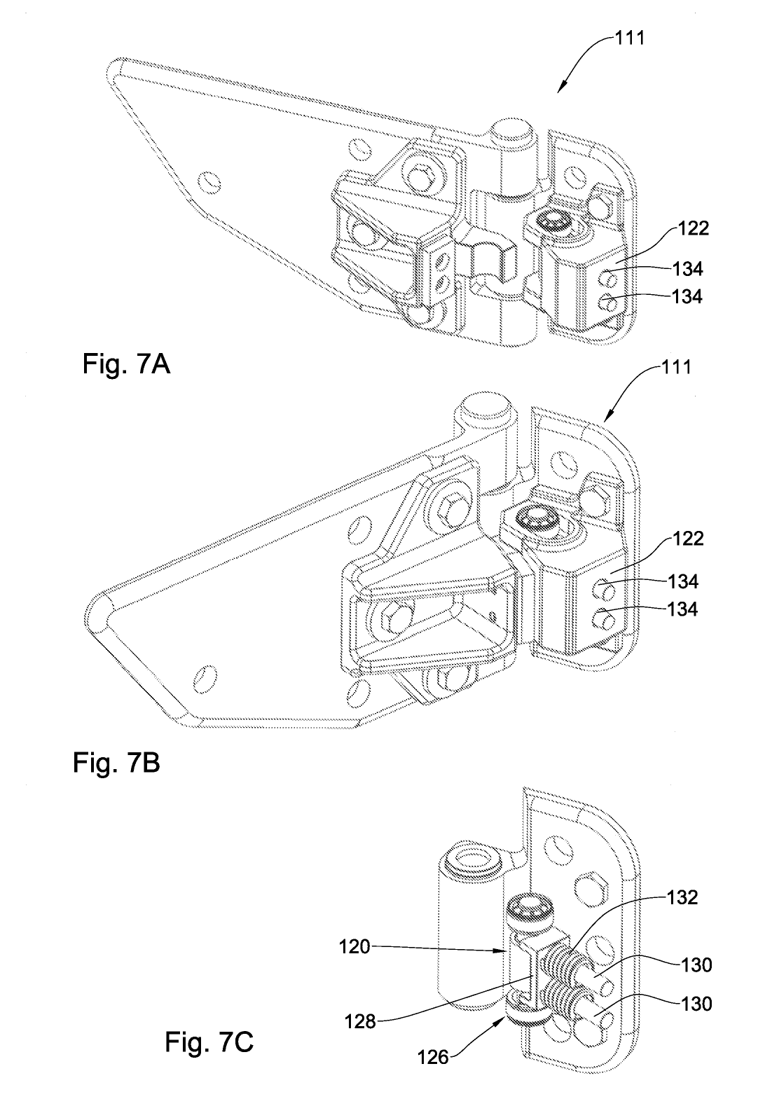

Reference is now made to FIG. 7A-C are corresponding to FIG. 1-3 above, illustrating another example of a retention mechanism 111 which has a similar principle of operation to the retention mechanism 11, with a slight structural modification in its biasing mechanism. The retention mechanism 111 comprises a plunger mechanism 126 configured to bear against a keeper 120, and two plunging rods 130 connected to a biasing plate 128, and having compression springs 132 disposed thereon between the biasing plate 128 and a housing 122.

The housing 122 is formed with two through-going apertures 134 sized so as to allow passage therethrough of the plunging rods 130, while preventing passage therethrough of the compression springs 132, so that the springs bear between the biasing plate 128 and the housing 122 when compressed, causing the biasing plate 128 to bias the keeper 120 toward the locking position.

One of the advantages of the above described clearance area lies in situations (e.g., emergency situations) when there is a need for an outside or an inside operator to open the door, at least to a slight angle. It should be appreciated that for such an operator is can be much easier to manipulate the door to this slight angle (e.g., the first angle α), if the retention mechanism does not resist to the opening of the door until the door reaches the slight angle. In order to allow this, the presently disclosed retention mechanism provides a clearance area, through which the door can be easily pass without resistance from the retention mechanism.

In additional, it is appreciated the less resistance there is for opening or closing a door (when its latch is located at the clearance area), the less time is needed for receiving the needed position of the door (e.g., the intermediate position). This saving of time may have an importance in different critical conditions in which time is important and should be saved.

Those skilled in the art to which this invention pertains will readily appreciate that numerous changes, variations and modifications can be made without departing from the scope of the invention mutatis mutandis.

1. A retention mechanism for a hinge mechanism of a door, the hinge mechanism being configured for articulating a door to the sidewall of a vehicle so as to enable pivoting of the door relative to the sidewall about an axis between a closed position and an open position, the retention mechanism comprising:
a. a first portion comprising a keeper and a biasing arrangement configured to bias the keeper toward a locking position, while allowing displacement of the keeper from the locking position to a disengaged position;
b. a second portion comprising a latch, the latch being configured to displace the keeper from its locking position to its disengaged position and comprising a seat for retaining the keeper therein in its locking position, so as to maintain the door in its open position when the keeper being retained in the seat;
wherein the retention mechanism, when operating in conjunction with the hinge mechanism, comprises a clearance area in which, during pivoting of the door between its closed and open positions, there is no contact between the keeper and the latch.

2. The retention mechanism according to claim 1, wherein when the door is pivoted between its closed and open positions, the latch is configured to pass through the clearance area between a first position in which the keeper and the latch are maximally distant from each other, and a second position in which the latch comes in contact with the keeper, the latch being configured for assuming a plurality of medial positions, in each of which, there is no contact between the latch and the keeper.

3. The retention mechanism according to claim 2, wherein at the second position of the latch, the door is configured to be in an intermediate position between the open position and the closed position of the door, and angled at a first angle with respect to the latter, and wherein at its open position, the door is rotated at a second angle with respect to its closed position, differing from the first angle.

4. The retention mechanism according to claim 3, wherein the first position of the latch is corresponding to the closed position of the door, and the second position of the latch is corresponding to the intermediate position of the door.

5. The retention mechanism according to claim 3, wherein the first angle is about 20 to about 50 degrees.

6. The retention mechanism according to claim 5, wherein the first angle is about 35 degrees.

7. The retention mechanism according to claim 3, wherein the second angle is about 50 to about 80 degrees.

8. The retention mechanism according to claim 7, wherein the second angle is about 70 degrees.

9. The retention mechanism according to claim 3, wherein the clearance area is configured to provide pivoting of the door between its closed position to its intermediate position, while keeping the latch and the keeper at a contact-free configuration.

10. The retention mechanism according to claim 1, wherein the retention mechanism is configured for being attached to an exterior side of a vehicle.

11. The retention mechanism according to claim 1, wherein the first and second portions are isolated from one another in the closed position of the door.

12. The retention mechanism according to claim 1, wherein the biasing arrangement comprises:
a. a biasing plate configured to bear against the keeper; and
b. a spring configured to bias the biasing plate toward the keeper.

13. The retention mechanism according to claim 1, wherein the first portion comprises a housing configured to constrain the keeper to linear motion.

14. The retention mechanism according to claim 1, further comprising a first plate and a second plate articulated to one another by the hinge mechanism, each of the first and second portions being rigidly mounted to the plates, correspondingly.

15. The retention mechanism according to claim 14, wherein the first and second plates are configured to be attached to the door and the sidewall of the vehicle, correspondingly.

16. A hinge mechanism for a door, the hinge mechanism having a retention mechanism mounted thereon and being configured to enable pivoting of the door relative to a sidewall about an axis between a closed position and an open position, the retention mechanism comprising:
a. a first portion comprising a keeper and a biasing arrangement configured to bias the keeper toward a locking position, while allowing displacement of the keeper from the locking position to a disengaged position;
b. a second portion comprising a latch, the latch being configured to displace the keeper from its locking position to its disengaged position and comprising a seat for retaining the keeper therein in its locking position, so as to maintain the door in its open position when the keeper being retained in the seat;
wherein the retention mechanism, when operating in conjunction with the hinge mechanism, comprises a clearance area in which, during pivoting of the door between its closed and open positions, there is no contact between the keeper and the latch.

17. The hinge mechanism according to claim 16, wherein when the door is pivoted between its closed and open positions, the latch is configured to pass through the clearance area between a first position in which the keeper and the latch are maximally distant from each other, and a second position in which the latch comes in contact with the keeper, the latch being configured for assuming a plurality of medial positions, in each of which, there is no contact between the latch and the keeper.

18. The hinge mechanism according to claim 17, wherein at the second position of the latch, the door is configured to be in an intermediate position between the open position and the closed position of the door, and angled at a first angle with respect to the latter, and wherein at its open position, the door is rotated at a second angle with respect to its closed position, differing from the first angle.

19. The hinge mechanism according to claim 18, wherein the first position of the latch is corresponding to the closed position of the door, and the second position of the latch is corresponding to the intermediate position of the door.

20. A vehicle comprising the retention mechanism according to claim 1.
